(19) United States
(12) Patent Application Publication
(10) Pub. No.: US 2013/0235196 A1
(43) Pub. Date: Sep. 12, 2013

(54) REAL-TIME MULTIMEDIA SIGNAL TRANSMISSION DEVICE

(71) Applicant: DIGILIFE TECHNOLOGIES CO., LTD., Taipei (TW)

(72) Inventors: Chen-Ping Yang, Taipei (TW); Allen Chang, Taipei (TW)

(73) Assignee: DIGILIFE TECHNOLOGIES CO., LTD., Taipei (TW)

(21) Appl. No.: 13/872,593

(22) Filed: Apr. 29, 2013

Related U.S. Application Data
(63) Continuation-in-part of application No. 13/337,557, filed on Dec. 27, 2011.

(30) Foreign Application Priority Data
Jun. 10, 2011 (TW) 100210559

(51) Int. Cl. H04N 7/18

(52) U.S. Cl. CPC H04N 7/18
USPC 348/143

(57) ABSTRACT

A real-time multimedia signal transmission device includes a case including a multimedia information capture section, a processing unit, a signal conversion section and a wireless transceiver section. The processing unit processes output of the multimedia information capture section to generate a multimedia signal. The signal conversion section processes the multimedia signal to generate a multimedia packet signal. The wireless transceiver section transmits the multimedia packet signal to at least one smart handheld device wirelessly linking the real-time multimedia signal transmission device. If receiving a remote control command from the at least one smart handheld device via the wireless transceiver section, the processing unit controls the real-time multimedia signal transmission device to perform a function control corresponding to the remote control command.

### CROSS-REFERENCE TO RELATED APPLICATIONS

This non-provisional application is a continuation-in-part patent application of U.S. application Ser. No. 13/337,557 filed on Dec. 27, 2011, which claims priority under 35 U.S.C. §119(a) on Patent Application No. 100210559 filed in Taiwan, R.O.C. on Jun. 10, 2011, the entire contents of which are hereby incorporated by reference.

### TECHNICAL FIELD

The disclosure relates to a real-time multimedia signal transmission device and more particularly to a real-time multimedia signal transmission device that can wirelessly link to smart handheld devices to provide a remote monitoring function and a remote control function.

### BACKGROUND

A conventional camcorder usually includes a camera and a display movably arranged at one lateral side of the camera. When using the camcorder to shoot pictures, the display is pivotally turned outward from the camera, and the camera is used for capturing static or dynamic images and sounds or used to play back the captured images. The images being captured are shown via the display to complete the function of shooting pictures.

Since the conventional camcorder is equipped with a display, it requires higher manufacturing cost and is sold at a high price. Further, with the conventional camcorder, a user has to always stay with the camcorder for capturing still or dynamic images and sounds. Therefore, the convenience in using the conventional camcorder is low.

It is therefore desirable to develop a device that has reduced manufacturing cost and can be remotely monitored while providing diversified functions.

### SUMMARY

A real-time multimedia signal transmission device according to an embodiment of the disclosure includes a case including a multimedia information capture section, a processing unit, a signal conversion section and a wireless transceiver section. The multimedia information capture section captures multimedia information. The processing unit is electrically connected to the multimedia information capture section, and processes output of the multimedia information capture section to generate multimedia signals. The signal conversion section is electrically connected to the processing unit, processes the multimedia signals to generate multimedia packet signals, and processes a remote control signal to obtain a remote control command. The wireless transceiver section is electrically connected to the signal conversion section, and wirelessly transmits the multimedia packet signals to at least one smart handheld device which links to the real-time multimedia signal transmission device wirelessly.

When the wireless transceiver section wirelessly receives a remote control signal from one of the at least one smart handheld device, the processing unit controls the real-time multimedia signal transmission device to perform a function control according to the remote control command.

### BRIEF DESCRIPTION OF THE DRAWINGS

The present disclosure will become more fully understood from the detailed description given herein below for illustration only and thus does not limit the present disclosure, wherein:

FIG. 1 is a schematic diagram of a real-time multimedia signal transmission device according to an embodiment of the disclosure in use;

FIG. 2 is a block diagram of the real-time multimedia signal transmission device in FIG. 1 according to an embodiment of the disclosure;

FIG. 3 is a flow chart of a multimedia signal transmission method according to an embodiment of the disclosure;

FIG. 4 is a flow chart of an automatic selection procedure according to an embodiment of the disclosure;

FIG. 5 is a schematic diagram of the real-time multimedia signal transmission device in FIG. 2 in use;

FIG. 6 is a flow chart of a remote control procedure according to an embodiment of the disclosure;

FIG. 7 is a schematic diagram of a real-time multimedia signal transmission device according to an embodiment of the disclosure in use;

FIG. 8 is a block diagram of the real-time multimedia signal transmission device in FIG. 7 according to an embodiment of the disclosure;

FIG. 9 is a flow chart of a multimedia signal transmission method according to an embodiment of the disclosure;

FIG. 10 is a flow chat of a multimedia signal transmission method according to an embodiment of the disclosure when the RF transceiving unit and the network transmission unit in FIG. 7 do not operate simultaneously;

FIG. 11 is a flow chart of an automatic selection procedure according to an embodiment of the disclosure; and

FIG. 12 is a schematic diagram of the real-time multimedia signal transmission device in FIG. 8 in use.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

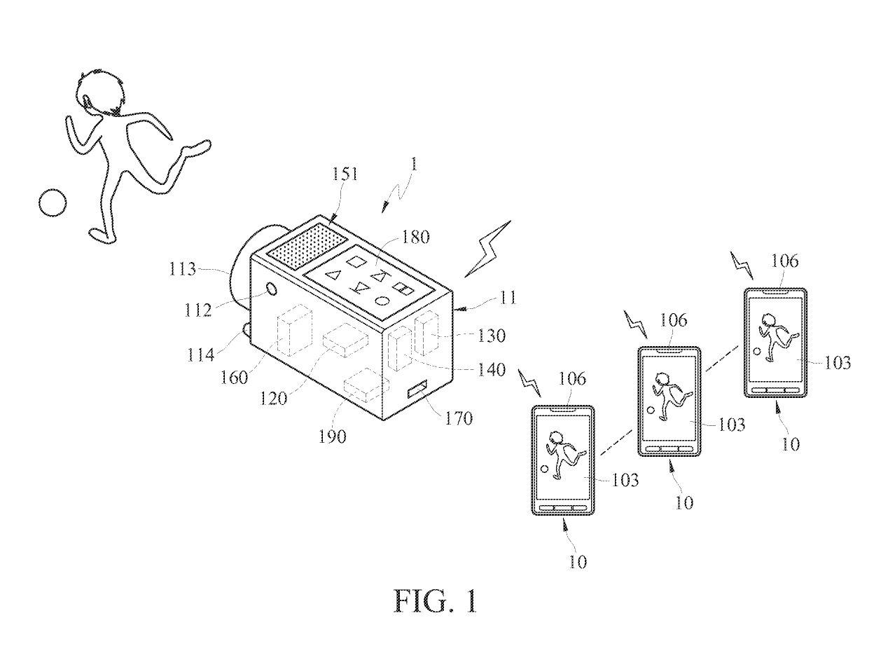

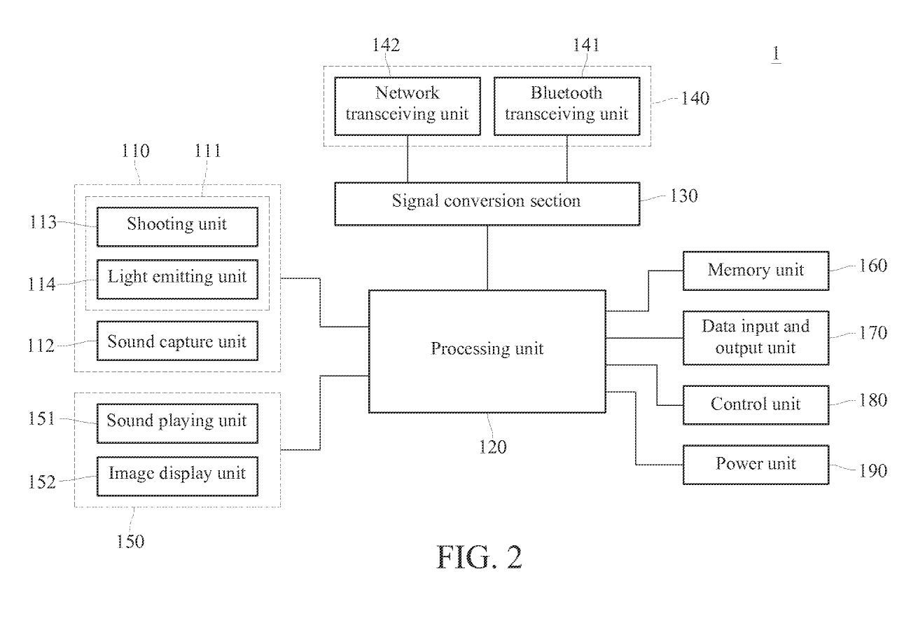

Refer to FIG. 1 which is a schematic diagram of a real-time multimedia signal transmission device according to an embodiment of the disclosure in use, and to FIG. 2 which is a block diagram of a real-time multimedia signal transmission device according to an embodiment of the disclosure. As shown, a real-time multimedia signal transmission device 1 in the disclosure can be used with at least one smart handheld device 10, e.g. a smart mobile phone, a smart personal digital assistant (PDA), a portable computer or a tablet computer.

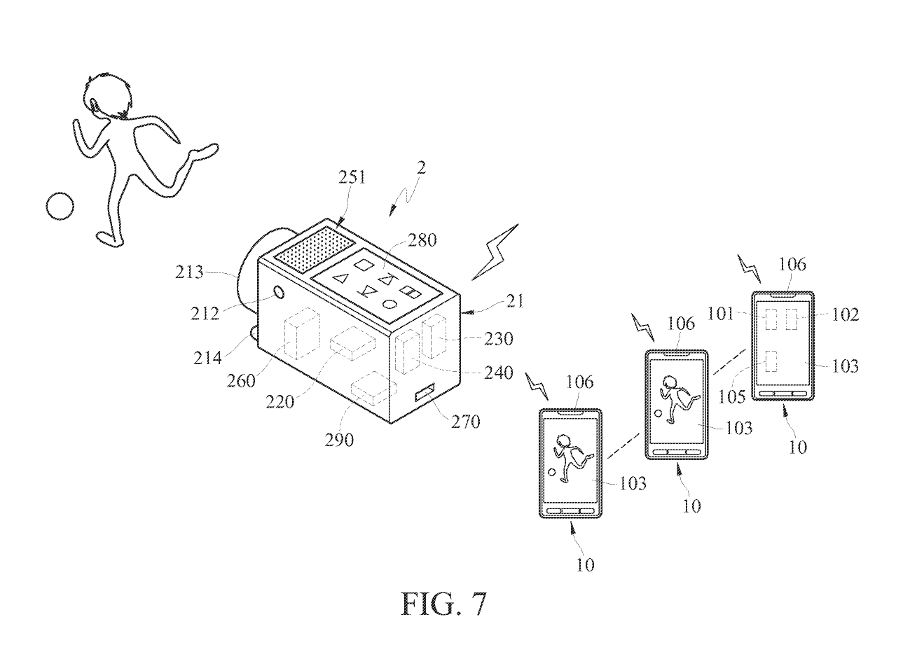

The smart handheld device 10 as shown in FIG. 7 includes a memory unit 101, a processing unit 102, a display 103, a wireless transceiver section 105 and a speaker 106.

The wireless transceiver section 105 is, e.g. a network transceiving unit, a Bluetooth transceiving unit, a radio frequency (RF) transceiving unit or a combination thereof The processing unit 102 is electrically connected to the memory unit 101, the display 103, the wireless transceiver section 105 and the speaker 106 to control the operation of each elements and access and process data or signal.

The real-time multimedia signal transmission device 1 has a case 11 including a multimedia information capture section 110, a processing unit 120, a wireless transceiver section 140 and a signal conversion section 130 according to an embodiment. The multimedia information capture section 110 and the signal conversion section 130 are electrically connected to the processing unit 120 respectively, and the wireless transceiver section 140 is electrically connected to the signal conversion section 130. Therefore, the processing unit 120 can control and coordinate the operation of each component in the real-time multimedia signal transmission device 2, and process and access data and signals. For example, the processing unit 120 receives and converts at least one of an image signal and a sound signal into a multimedia signal. The processing unit 120 is, for example, a microprocessor.

The multimedia information capture section 110 is used for capturing multimedia information and includes at least one of an image capture section 111 and a sound capture unit 112. The image capture section 111 is used for capturing external images, processing the captured images to generate image signals, and transmitting the image signals to the processing unit 120. In an embodiment, the image capture section 111 includes a shooting unit 113, a light emitting unit 114, or a combination thereof. The shooting unit 113 is, for example, a lens with a CCD (charge coupled device) sensor or a CMOS (complementary metal-oxide-semiconductor) sensor, and having the zooming function for shooting both static and dynamic images. In the event of insufficient light source at the shooting site, the light emitting unit 114, e.g. a light emitting diode (LED), can serve as an aid in shooting. The sound capture unit 112 is, for example, a microphone, used for capturing external sounds, processing the captured sounds to generate sound signals, and transmitting the sound signals to the processing unit 120.

In an embodiment, the signal conversion section 130 is a secure digital input and output (SDIO) interface unit. The signal conversion section 130 is used for receiving the multimedia signal from the processing unit 120 and processing the multimedia signal to generate a multimedia packet signal according to a wireless transceiving standard of the wireless transceiver section 140. On the other hand, the signal conversion section 130 is also used for processing a remote control signal to obtain a remote control command, and transmitting the remote control command to the processing unit 120.

The wireless transceiver section 140 includes a Bluetooth transceiving unit 141 and a network transceiving unit 142, e.g. a Wifi transceiving module. The Bluetooth transceiving unit 141 is used for receiving the multimedia packet signal from the signal conversion section 130, and transmitting the multimedia packet signal to the smart handheld device 10 when wirelessly linking to the wireless transceiver section 105 of the smart handheld device 10. The network transceiving unit 142 is used for receiving the multimedia packet signal from the signal conversion section 130, and transmitting the multimedia packet signal to the smart handheld device 10 when wirelessly linking to the wireless transceiver section 105 of the smart handheld device 10, or to upload the multimedia packet signal to a network. Furthermore, the Bluetooth transceiving unit 141 and the network transceiving unit 142 are further used for receiving the remote control signal sent out from one smart handheld device 10, and transmitting the remote control signal to the signal conversion section 130.

In the disclosure, one of the Bluetooth transceiving unit 141 and the network transceiving unit 142 is selected to perform wireless transmission. In other words, while the Bluetooth transceiving unit 141 operates, the network transceiving unit 142 does not operate. For example, when the real-time multimedia signal transmission device 1 is used in the vicinity of the smart handheld device 10, the Bluetooth transceiving unit 141 is selected to wirelessly link to the wireless transceiver section 105 of the smart handheld device 10. On the other hand, when the real-time multimedia signal transmission device 1 is used at a location quite distant from the smart handheld device 10, the network transceiving unit 142 is selected to wirelessly link to the wireless transceiver section 105 of the smart handheld device 10.

Moreover, the real-time multimedia signal transmission device 1 further includes at least one of a multimedia information playing section 150, a memory unit 160, a data input and output unit 170, a control unit 180 and a power unit 190. The multimedia information playing section 150, the memory unit 160, the data input and output unit 170, the control unit 180 and the power unit 190 are respectively connected to the processing unit 120 electrically.

The multimedia information playing section 150 includes at least one of a sound playing unit 151 and an image display unit 152. The sound playing unit 151 is used for receiving the multimedia signal from the processing unit 120 to play sounds. The sound playing unit 151 can be, for example, a speaker. The image display unit 152 is used for receiving the multimedia signal from the processing unit 120 to display images. The image display unit 152 can be, for example, a display panel.

The memory unit 160 is, for example, a memory, and is used for storing the multimedia signal, and then the stored multimedia signal is wirelessly transmitted to the smart handheld device 10 later for playing, or is directly played via the multimedia information playing section 150 later.

The data input and output unit 170 is one of various types of connection ports. Via the data input and output unit from a terminal end, other multimedia signals can be input to the processing unit 120 and then played via the smart handheld device 10 or directly played via the multimedia information playing section 150. The data input and output unit 170 is also used for outputting the multimedia signals obtained by capturing multimedia information to other electronic devices (not shown), such as a hard disk, a memory card and a computer.

The control unit 180 is, for example, a set of physical switches or keys or a set of virtual switches or keys. The virtual switches or keys can be shown on the image display unit 152 in the multimedia information playing section 150 for touch control. The control unit 180 allows a user to input commands. The commands are transmitted to the processing unit 120. Via commands provided by the control unit 180, the processing unit 120 controls the real-time multimedia signal transmission device 1 to perform a function control corresponding to each command, such as power on or off, focusing and zooming of the lens of the image capture section, recording function on or off, selection of transmission destinations, transmission function on or off, or selection of transceiving units.

The power unit 190 is used for supplying power to all elements in the real-time multimedia signal transmission device 1. The power unit 190 is, for example, an internal power supply or an external power supply, depending on actual need in use. An internal power supply is, for example, a general battery or a rechargeable battery, and an external power supply is, for example, a power generator or an outlet power source.

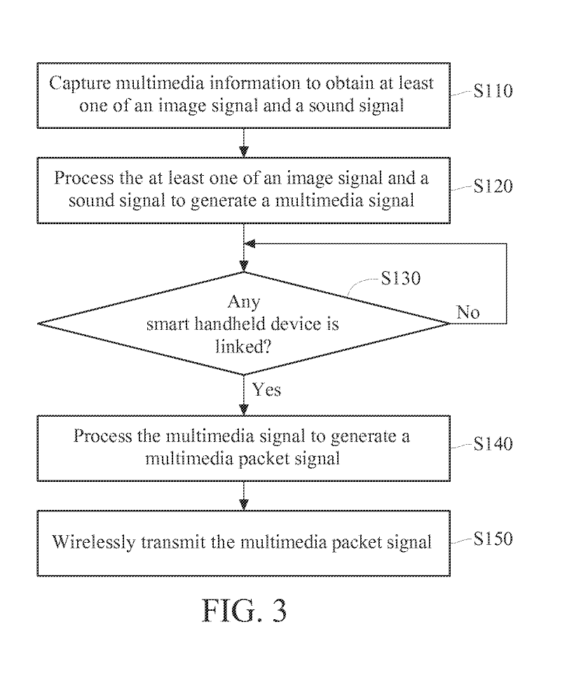

The relative multimedia signal transmission method is described as follows. FIG. 3 illustrates a flow chart of a multimedia signal transmission method according to an embodiment of the disclosure. Firstly, a user can use the multimedia information capture section 110 in the real-time multimedia signal transmission device 1 in FIG. 2 to capture multimedia information to obtain at least one of an image signal and a sound signal (step S110). If the real-time multimedia signal transmission device 1 is a sound recorder, the sound capture unit 112 captures sounds to obtain sound signals. If the real-time multimedia signal transmission device 1 is a camera without a microphone, the image capture section 111 captures images to obtain image signals. If the real-time multimedia signal transmission device 1 is a video camera or a digital camera having a microphone, the image capture section 111 and the sound capture unit 112 respectively capture sounds and images to obtain image signals and sound signals.

Subsequently, the processing unit 120 receives the at least one of the image signal and the sound signal to generate a multimedia signal (step S120). The processing unit 120 determines whether any smart handheld device 10 is linked (step S130). Assume that there are three smart handheld devices 10 shown in FIG. 1, it is understood the real-time multimedia signal transmission device 1 can be wirelessly linked to at least one of the three smart handheld devices 10. When the processing unit 120 does not detect any smart handheld device 10 wirelessly linked to the wireless transceiver section 140, the processing unit 120 waits. When at least one smart handheld device 10 is wirelessly linked to the wireless transceiver section 140, the processing unit 120 transmits the multimedia signal to the signal conversion section 130.

After the signal conversion section 130 processes the multimedia signal to generate a multimedia packet signal and transmits the multimedia packet signal to the wireless transceiver section 140 (step S140), one of the Bluetooth transceiving unit 141 and the network transceiving unit 142 in the wireless transceiver section 140 wireless transmits the multimedia packet signal to at least one smart handheld device 10 (step S150).

Therefore, the smart handheld device 10 can display or play multimedia information of the multimedia signal of the received multimedia packet signal in real time, via its display 103 and speaker 106. Further, the multimedia signal can be stored in the memory unit 101 of the smart handheld device 10, allowing a user to repeatedly play the multimedia information on the smart handheld device 10.

In step S130, one of the Bluetooth transceiving unit 141 and the network transceiving unit 142 in FIG. 2 can be selected. In an embodiment, the processing unit 120 directly selects one of the Bluetooth transceiving unit 141 and the network transceiving unit 142 according to a selection command inputted by the control unit 180.

In this and some embodiments, the processing unit 120 automatically selects the

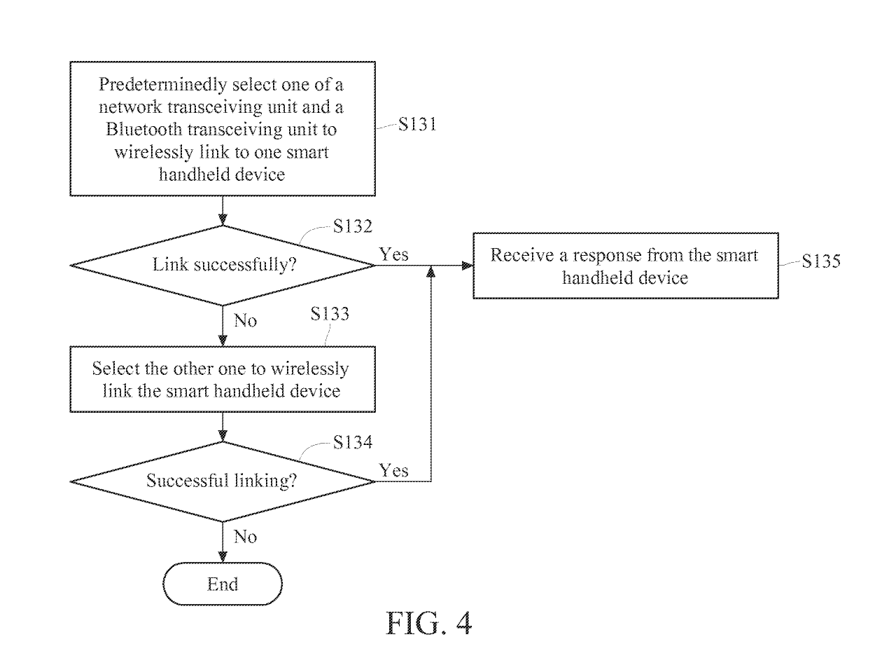

Bluetooth transceiving unit 141 or the network transceiving unit 142 through an automatic selection procedure as shown in FIG. 4 which is a flow chart of step S120 according to an embodiment of the disclosure. In other words, preset one of the Bluetooth transceiving unit 141 and the network transceiving unit 142 is selected (step S131).

When the preset one of the Bluetooth transceiving unit 141 and the network transceiving unit 142 is linked successfully (step S132), the preset one of the Bluetooth transceiving unit 141 and the network transceiving unit 142 will receive a response sent from the linked smart handheld device 10 (S135). When the preset of the Bluetooth transceiving unit 141 and the network transceiving unit 142 is linked unsuccessfully (step S 132), the processing unit 120 selects the other one of the Bluetooth transceiving unit 141 and the network transceiving unit 142 (step S133). When the other one of the

Bluetooth transceiving unit 141 and the network transceiving unit 142 links to the smart handheld device 10 unsuccessfully (step S134), the processing unit 120 waits or pauses wireless transmission. Otherwise, the other one of the Bluetooth transceiving unit 141 and the network transceiving unit 142 will receive a response sent from the linked smart handheld device 10 (step S135). Through the response sent out from the linked smart handheld device 10, the processing unit 120 can know what to drive for wireless transmission.

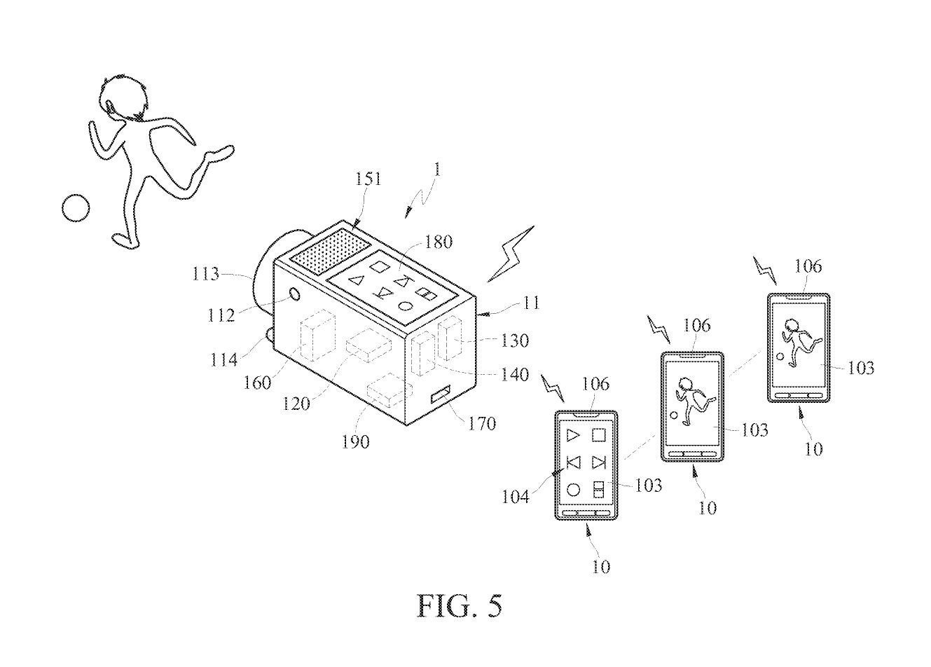

In the disclosure, a remote control function is available when a plurality of smart handheld devices 10 are linked to the real-time multimedia signal transmission device 1 as shown in FIG. 5. One of the smart handheld devices 10 is set as a remote controller and can utilize its built-in player module 104 to remotely control or actuate various functions of the real-time multimedia signal transmission device 1. The other ones of the smart handheld devices 10 are set as remote receivers and continuously receive the multimedia packet signal outputted by the real-time multimedia signal transmission device 1 for playing.

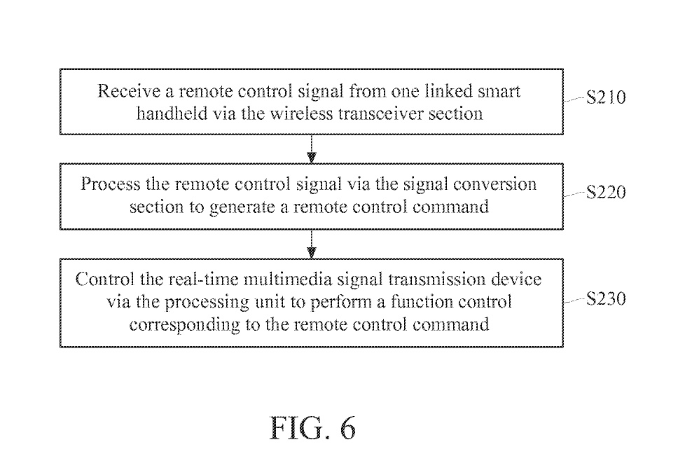

FIG. 6 is a flow chart of a remote control procedure according to an embodiment of the disclosure. When the remote controller links to one of the Bluetooth transceiving unit 141 and the network transceiving unit 142, virtual switches or keys shown on the player module 104 can be used for inputting a zooming-in command, and then the wireless transceiver section 105 sends a corresponding remote control signal to the wireless transceiver section 140 of the real-time multimedia signal transmission device 1 (step S210).

After the signal conversion section 130 processes the remote control signal transmitted by the wireless transceiver section 140 to obtain a remote control command and transmit the remote control command to the processing unit 120 (step S220), the processing unit 120 controls the real-time multimedia signal transmission device 1 to perform a corresponding function control (step S230). For example, the shooting unit 213 performs the zoom-in function according to the remote control command, so as to update the multimedia signal. Subsequently, the updated multimedia signal carried by the multimedia packet signal is wirelessly transmitted to the remote receiving devices for playing.

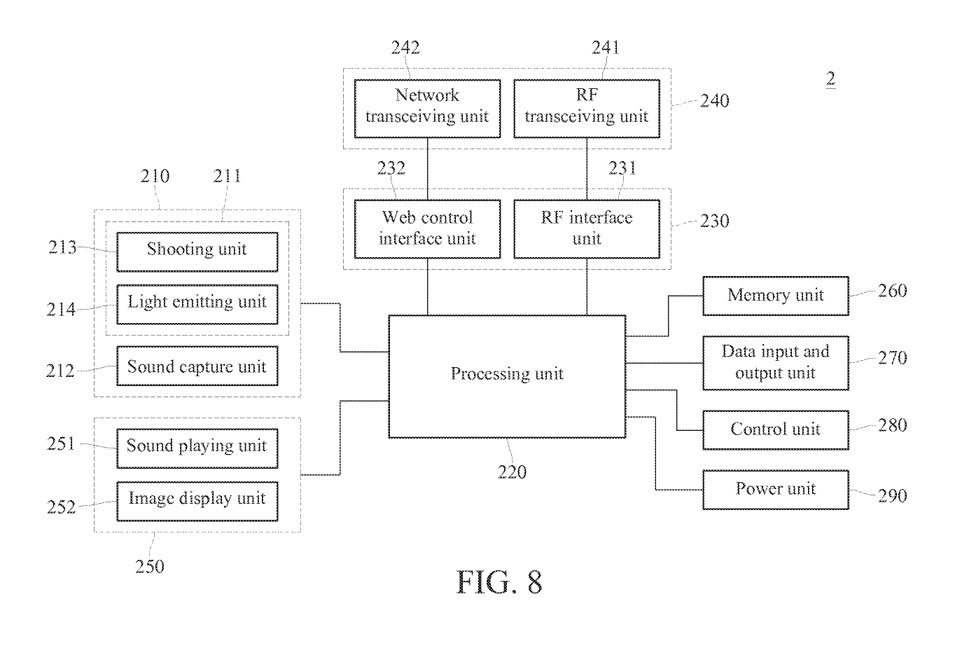

Refer to FIG. 7 which is a schematic diagram of a real-time multimedia signal transmission device according to an embodiment of the disclosure in use, and to FIG. 8 which is a block diagram of the real-time multimedia signal transmission device in FIG. 7 according to an embodiment of the disclosure. A real-time multimedia signal transmission device 2 can be used with at least one smart handheld device 10. The smart handheld device 10 in FIG. 1 and that in FIG. 7 are the same, thus be not described again hereinafter.

The real-time multimedia signal transmission device 2 has a case 21 including a multimedia information capture section 210, a processing unit 220, a signal conversion section 230 and a wireless transceiver section 240 according to an embodiment. The multimedia information capture section 210 and the processing unit 220 are the same as the multimedia information capture section 110 and the processing unit 120 in FIG. 2, thus being not described again hereinafter.

The signal conversion section 230 includes a radio frequency (RF) interface unit 231 and a Web control interface unit 232. The wireless transceiver section 240 includes a RF transceiving unit 241 and a network transceiving unit 242. The RF interface unit 231 is electrically connected between the processing unit 220 and the RF transceiving unit 241 and used for processing the multimedia signal to generate a multimedia packet signal, i.e. a first multimedia packet signal, according to its wireless transceiving standard. The RF transceiving unit 241 is used for wirelessly transmitting the first multimedia packet signal to the smart handheld device 10. The Web control interface unit 232 is electrically connected between the processing unit 220 and the network transceiving unit 242 and used for processing the multimedia signal to generate a multimedia packet signal, i.e. a second multimedia packet signal, according to its wireless transceiving standard. The network transceiving unit 242 is used for wirelessly transmitting the second multimedia packet signal to the smart handheld device 10 and uploading the second multimedia packet signal to a network.

Besides, the RF transceiving unit 241 and the network transceiving unit 242 are also used for receiving a remote control signal and transmitting the remote control signal to the RF interface unit 231 and the Web control interface unit 232 respectively when one smart handheld device 10 is installed with an application software and sends out the remote control signal. The RF interface unit 231 and the Web control interface 232 are also used for processing the remote control signal to obtain a remote control command which is used for controlling the real-time multimedia signal transmission device 2 via the processing unit 220 to perform a corresponding function control, e.g. focusing and zooming of the lens of the image capture section 211, capture function on and off, recording function on or off, selection function of transmission destinations, transmission function on or off or the like. The RF interface unit 231 is, for example, a universal asynchronous receiver and transmitter (UART) interface unit or a universal synchronous asynchronous receiver and transmitter (USART) interface unit. The RF transceiving unit 241 is, for example, a RF 2.4G transceiving module. The network transceiving unit 242 is, for example, a Wifi transceiving module.

In this and some embodiments, the real-time multimedia signal transmission device 2 further includes at least one of a multimedia information playing section 250, a memory unit 260, a data input and output unit 270, a control unit 280 and a power unit 290. The multimedia information playing section 250, the memory unit 260, the data input and output unit 270, the control unit 280 and the power unit 290 can refer to the multimedia information playing section 150, the memory unit 160, the data input and output unit 170, the control unit 180 and the power unit 190 in FIG. 2 respectively, thus being not described again hereinafter. The relative multimedia signal transmission method is described as follows.

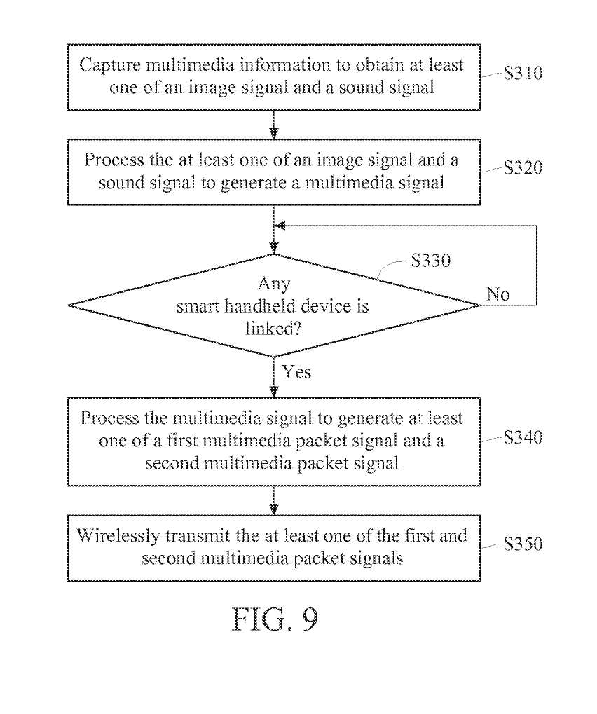

FIG. 9 illustrates a multimedia signal transmission method according to an embodiment of the disclosure. After capturing multimedia information via the multimedia information capture section 210 in FIG. 8 to obtain at least one of an image signal and a sound signal (step S310) and then processing the at least one of the image signal and the sound signal to generate a multimedia signal via the processing unit 220 (step S320), the processing unit 220 determines whether the wireless transceiver section 240 has linked to any smart handheld device 10 in FIG. 7 (step S330).

When no smart handheld device 10 has been linked, the processing unit 220 waits. When at least one smart handheld device 10 has been linked, the signal conversion section 230 processes the multimedia signal to generate at least one of a first multimedia packet signal and a second multimedia packet signal (step S340). Finally, the wireless transceiver section 240 wireless transmits the at least one of the first and second multimedia packet signals to the at least one smart handheld device 10 (step S350).

In an embodiment, the RF transceiving unit 241 and the network transceiving unit 242 can operate simultaneously, that is, the RF interface unit 231 and the Web control interface unit 232 operate simultaneously. The first and second multimedia packet signals can be sent out simultaneously, and the at least one smart handheld device 10 can receive one of the first and second multimedia packet signals according to its wireless transceiving standard.

In this and some embodiments, the RF transceiving unit 241 and the network transceiving unit 242 do not operate simultaneously according to various usage requirements, so that the first and second multimedia packet signals are not sent out simultaneously. For example, when the real-time multimedia signal transmission device 2 is used in the vicinity of the smart handheld device 10, the RF transceiving unit 241 is selected to wirelessly linking to the smart handheld device 10. On the other hand, when the real-time multimedia signal transmission device 2 is used at a location quite distant from the smart handheld device 10, the network transceiving unit 242 is selected to wirelessly linking to the smart handheld device 10.

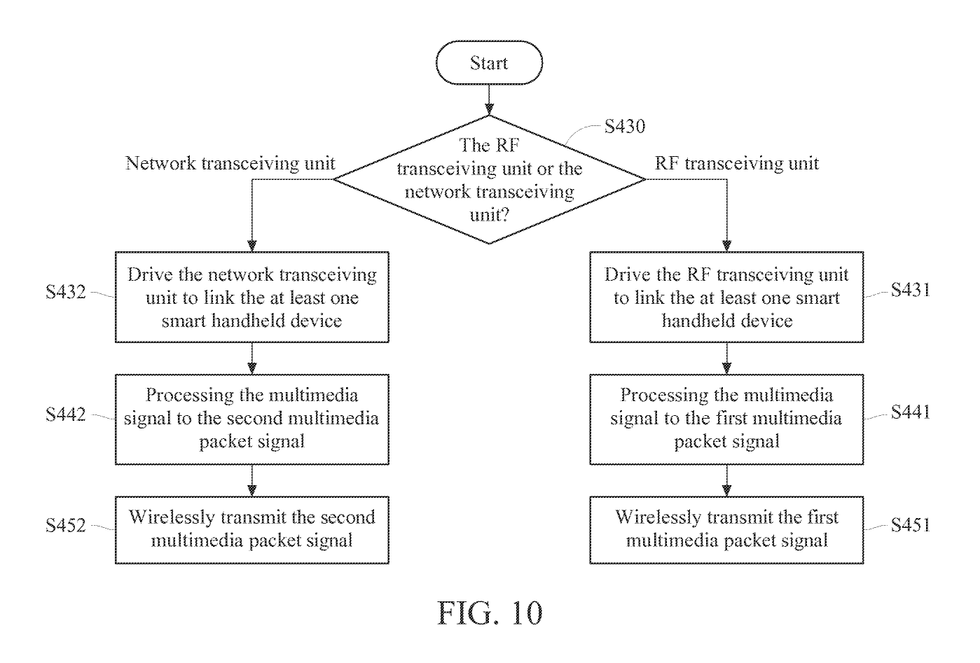

Refer to FIG. 10 which is a flow chat of a multimedia signal transmission method according to an embodiment of the disclosure when the RF transceiving unit and the network transceiving unit in FIG. 7 do not operate simultaneously. In step S330 in FIG. 9, the processing unit 220 determines which one of the RF transceiving unit 241 and the network transceiving unit 242 in FIG. 7 is selected (step S430).

When the RF transceiving unit 241 is selected, the processing unit 220 drives the RF transceiving unit 241 to wirelessly link to the at least one smart handheld device 10 (step S431). After the RF transceiving unit 241 links to the at least one smart handheld device 10, the RF interface unit 231 processes the multimedia signal obtained in step 5220 in

FIG. 9 to generate the first multimedia packet signal (step S441), and the RF transceiving unit 241 wirelessly transmits the first multimedia packet signal to the at least one smart handheld device 10 (step S451).

On the other hand, when the network transceiving unit 242 is selected in step 5430, the processing unit 220 drives the network transceiving unit 242 to link to the at least one smart handheld device 10 (step S432). After the network transceiving unit 242 links to the at least one smart handheld device 10, the Web control interface unit 232 processes the multimedia signal to generate the second multimedia packet signal (step S442), and the network transceiving unit 242 wirelessly transmits the second multimedia packet signal to the at least one smart handheld device 10 (step S452).

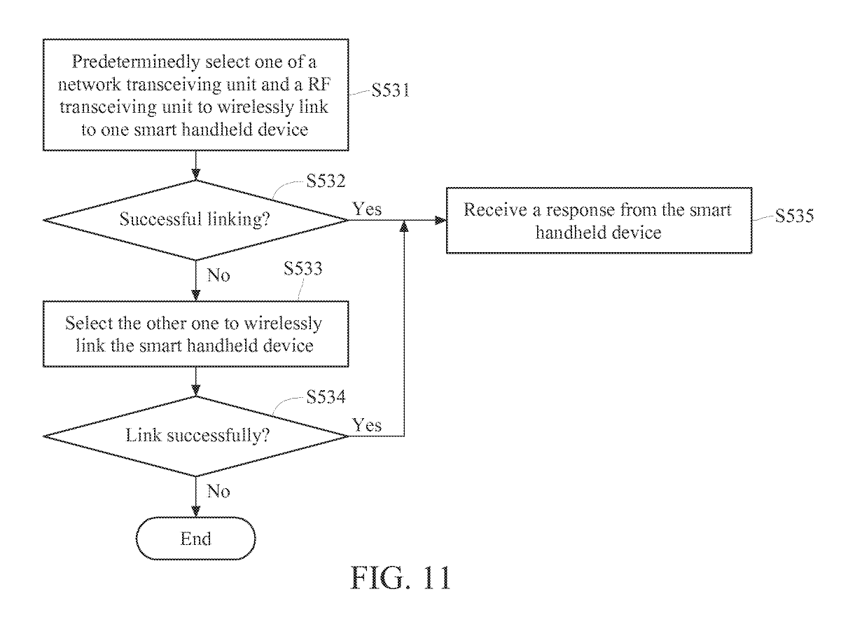

In an embodiment, the processing unit 220 directly selects one of the RF transceiving unit 241 and the network transceiving unit 242 to perform wireless communication according to a selection command inputted by the control unit 280. In this and some embodiments, the processing unit 220 automatically selects one of the RF transceiving unit 241 and the network transceiving unit 242 through an automatic selection procedure as shown in FIG. 11 being a flow chart of an automatic selection procedure according to an embodiment of the disclosure.

Firstly, preset one of the RF transceiving unit 241 and the network transceiving unit 242 is selected (step S531). When the preset one of the RF transceiving unit 241 and the network transceiving unit 242 is linked successfully (step S532), the preset one of the RF transceiving unit 241 and the network transceiving unit 242 will receive a response sent from the linked smart handheld device 10 (S535). When the preset one of the RF transceiving unit 241 and the network transceiving unit 242 is linked unsuccessfully (step S532), the processing unit 220 selects the other one of the RF transceiving unit 241 and the network transceiving unit 242 (step S533). When the other one of the RF transceiving unit 241 and the network transceiving unit 242 links to the smart handheld device 10 unsuccessfully (step S534), the processing unit 220 waits or pauses wireless transmission. Otherwise, the other one of the RF transceiving unit 241 and the network transceiving unit 242 will receive a response sent from the linked smart handheld device 10 (step S535). Through the response sent out from the linked smart handheld device 10, the processing unit 220 can know what to drive for wireless transmission.

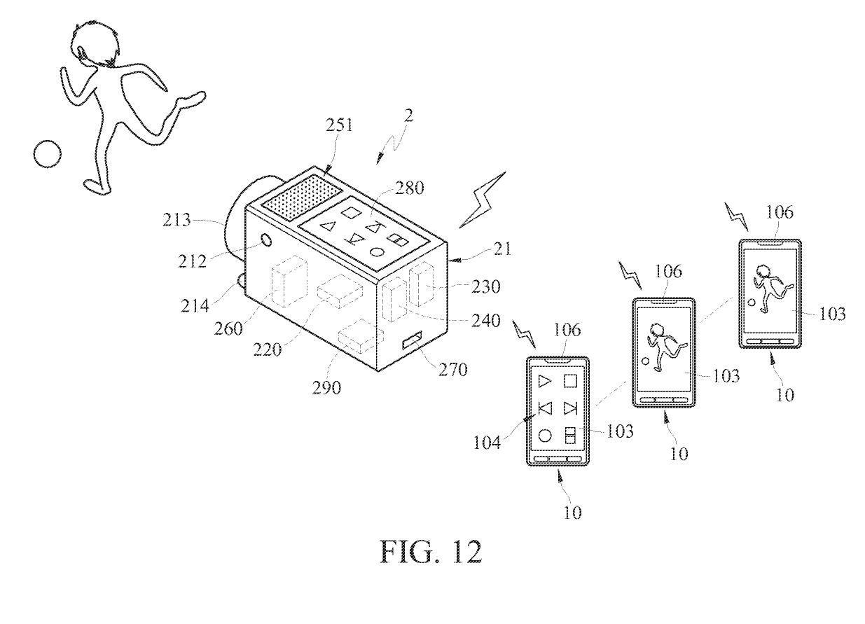

FIG. 12 is a schematic diagram of the real-time multimedia signal transmission device in FIG. 7 in use. When a plurality of smart handheld devices 10 are linked to the real-time multimedia signal transmission device 2, one of the smart handheld devices 10 can utilize its built-in player module 104 to remotely control or actuate various functions of the real-time multimedia signal transmission device 2. The other ones of the smart handheld devices 10 continuously receive the multimedia packet signal outputted by the real-time multimedia signal transmission device 2 for playing. The relative remote control procedure can refer from the description in FIG. 6, thus being not described again hereinafter.

In the disclosure, the real-time multimedia signal transmission device can utilize the display of the smart handheld device to watch captured images or listen to captured sounds, and provide a remote control function to the smart handheld device, so that the multimedia information captured by the real-time multimedia signal transmission device can be remotely monitored via the smart handheld device, making the real-time multimedia signal transmission device diversified in function. Thus, when using the real-time multimedia signal transmission device to capture multimedia information, the user does not need to always stay with the device but can monitor the captured images at a nearby or a distant location via the smart handheld device.

In the case of monitoring the captured images from a nearby location, such as in a car, the real-time multimedia signal transmission device may serve as an event data recorder, and a backseat passenger may monitor the captured images via a smart handheld device. In the case of monitoring the captured images from a remote location, such as at the site of a game or a show, the real-time multimedia signal transmission device may be mounted to a location closer to the site of the game or the show, and the user may conveniently watch the game or the show at a somewhat distant location via a smart handheld device.

What is claimed is:

1. A real-time multimedia signal transmission device, comprising:
a case, comprising:
a multimedia information capture section used for capturing multimedia information;
a processing unit used being electrically connected to the multimedia information capture section, and used for processing an output of the multimedia information capture section to generate multimedia signals;
a signal conversion section being electrically connected to the processing unit, and used for processing the multimedia signals to generate multimedia packet signals, and processing a remote control signal to obtain a remote control command; and
a wireless transceiver section being electrically connected to the signal conversion section, and used for wirelessly transmitting the multimedia packet signals to at least one smart handheld device which links to the real-time multimedia signal transmission device wirelessly;
wherein when the wireless transceiver section wirelessly receives a remote control signal from one of the at least one smart handheld device, the processing unit controls the real-time multimedia signal transmission device to perform a function control according to the remote control command.

2. The real-time multimedia signal transmission device according to claim 1, wherein the signal conversion section comprises a radio frequency (RF) interface unit, the wireless transceiver section comprises a RF transceiving unit, the RF interface unit is electrically connected between the processing unit and the RF transceiving unit, and used for processing the multimedia signal to generate a first multimedia packet signal as the multimedia packet signal, and processing the remote control signal to obtain the remote control command, the RF transceiving unit is used for wirelessly transmitting the first multimedia packet signal to the at least one smart handheld device and receiving the remote control signal from the smart handheld device linking to the RF transceiving unit.

3. The real-time multimedia signal transmission device according to claim 2, wherein the RF interface unit is a universal asynchronous receiver and transmitter (UART) interface unit or a universal synchronous asynchronous receiver and transmitter (USART).

4. The real-time multimedia signal transmission device according to claim 2, wherein the RF transceiving unit is a RF 2.4G transceiving module.

5. The real-time multimedia signal transmission device according to claim 2, wherein the signal conversion section further comprises a Web control interface unit, the wireless transceiver section further comprises a network transceiving unit, the Web control interface unit is electrically connected between the processing unit and the network transceiving unit, and used for processing the multimedia signal to generate a second multimedia packet signal as the multimedia packet signal, and processing the remote control signal to obtain the remote control command, and the network transceiving unit is used for wirelessly receiving the second multimedia packet signal to the at least one smart handheld device, and receiving the remote control signal from the smart handheld device linking to the network transceiving unit.

6. The real-time multimedia signal transmission device according to claim 5, wherein the network transceiving unit is a Wifi transceiving module.

7. The real-time multimedia signal transmission device according to claim 5, wherein at least one of the Web control interface unit and the RF interface unit is selected to operate.

8. The real-time multimedia signal transmission device according to claim 7, wherein the case further comprises a control unit, and the control unit is electrically connected to the processing unit and used for inputting a selection command which is used for selecting one of the RF transceiving unit and the network transceiving unit to operate.

9. The real-time multimedia signal transmission device according to claim 7, wherein the processing unit automatically selects the Web control interface unit or the RF interface unit to perform wireless communication by determining whether preset one of the Web control interface unit and the RF interface unit links to the smart handheld device successfully, and the processing unit selects the other one of the Web control interface unit and the RF interface unit when the preset one of the Web control interface unit and the RF interface unit links the smart handheld device unsuccessfully.

10. The real-time multimedia signal transmission device according to claim 1, wherein the wireless transceiver section comprises a network transceiving unit and a Bluetooth transceiving unit, and one of the network transceiving unit and the Bluetooth transceiving unit is selected to perform wireless communication.

11. The real-time multimedia signal transmission device according to claim 10, wherein the case further comprises a control unit, the control unit is electrically connected to the processing unit and used for inputting a selection command used for selecting one of the network transceiving unit and the Bluetooth transceiving unit to operate.

12. The real-time multimedia signal transmission device according to claim 10, wherein the processing unit automatically selects the network transceiving unit or the Bluetooth transceiving unit to perform wireless communication by determining whether preset one of the network transceiving unit and the Bluetooth transceiving unit links to the smart handheld device successfully, and the processing unit selects the other one of the network transceiving unit and the Bluetooth transceiving unit when the preset one of the network transceiving unit and the Bluetooth transceiving unit links the smart handheld device unsuccessfully.

13. The real-time multimedia signal transmission device according to claim 10, wherein the signal conversion section comprises a secure digital input and output (SDIO) interface unit.

14. The real-time multimedia signal transmission device according to claim 1, wherein when a quantity of the at least one smart handheld device is two, one of the two smart handheld devices transmits the remote control signal to the real-time multimedia signal transmission device, the multimedia information capture section performs the function control corresponding to the remote control command to update the multimedia signal, and the other one of the two smart handheld devices wirelessly obtains the updated multimedia signal for playing.

15. The real-time multimedia signal transmission device according to claim 1, wherein the case further comprises at least one of an image displaying unit and a sound playing unit, being electrically connected to the processing unit and used for playing the multimedia signals.

16. The real-time multimedia signal transmission device according to claim 1, wherein the case further comprises a data input and output unit being electrically connected to the processing unit and used for receiving another multimedia signal from a terminal end.

17. The real-time multimedia signal transmission device according to claim 1, wherein the case further comprises a memory unit used for storing the multimedia signals.
